(19) United States
(12) Patent Application Publication
(10) Pub. No.: US 2005/0006594 A1
(43) Pub. Date: Jan. 13, 2005

(54) Simple systems for accurately detecting and measuring only fluorescent radiation from a sample in a plastic test tube

(76) Inventors: Anthony Calderoni, Bristol, CT (US); Hugh Busey, Cheshire, CT (US)

Correspondence Address: Theodore L. Heying;c/o Corvin Inc., 925 Sherman Ave., Hamden, CT, 06514, US

(21) Appl. No.: 10/870,739

(22) Filed: Jun. 17, 2004

Related U.S. Application Data
(60) Provisional application No. 60/484,904, filed on Jul. 7, 2003.

(51) Int. Cl. G01N 21/64

(52) U.S. Cl. 250/458.1; 250/459.1

(57) ABSTRACT

System for determining the Fluorescent Radiation from a sample which has been irradiated with other fluorescent radiation comprising a fluorescent radiation source with its radiation collimated downward into a plastic test tube containing the sample at the bottom which tube is contained in a temperature control block. Once the sample emits its own fluorescent radiation which escapes from the tube through an aperture at the side and then is reflected by a mirror situated at an angle which redirects the fluorescent radiation downward again at a point not in the same plane as the radiation from the initial source. The fluorescent radiation then passes through focusing lenses and a filter which removes all radiation other than that fluorescent radiation emitted by the sample. The sample's radiation then contacts a photosensing device which measures the sample's fluorescent radiation which measurement is processed by an electronic processor which displays the result for the user of the system.

This application claims benefit of provisional patent application Ser. No. 60/484,904, filed Jul. 7, 2003.

### BACKGROUND—FIELD OF INVENTION

Fluorescent radiation involves the emission of one or more photons by a molecule or atom which has absorbed a quantity of electromagnetic radiation from some source. Typically, the emission which is of longer wavelength than the excitatory radiation occurs within 10⁻⁸ seconds which differentiates fluorescent radiation from other forms of radiation. Consequently the fluorescent emissions of many substances of interest is often measured to identify those materials and/or to quantify the amount of those substances in a given sample.

The use of fluorescence either naturally generated or induced has been use to identify samples or biological species for many years. As the technology has become more developed and advanced, a need for more sophisticated and accurate methods of measuring fluorescent radiation in very small samples has become apparent. Attributes of such determinations that need attention are accurate control of the temperature of a sample during its analysis, the ability to handle smaller samples efficiently and inexpensively, a need for rapid determinations and protection of the sample or reading apparatus from stray radiation especially stray fluorescence generated from items other than the sample as well as ability for automation etc.

For example beginning in 1993, Hearst et. al. have devoted substantial resources to developing a system which holds a given sample in a precise, fixed relationship with the energy source, in this case light, and in such a manner that a complicated, precise control system to maintain the temperature at a given level can surround the sample. (U.S. Pat. Nos. 5,184,020; 5,854,967; 6,258,319; 6,461,567; 6,680,025; 5,683,661, 5,503,721 and U.S. Patent Application 20020044885) This of course tends to make the system cumbersome, expensive and limited in application..

In U.S. Pat. No. 5,773,835, Sinofsky uses rather expensive fluoropolymer cladding in certain specific ways to reduce background fluorescence to surround a radiation collecting optical fiber and/or the source of excitation radiation which seems to limit the usefulness of the system to determining cancerous tissues. In another approach, Bogart (U.S. Pat. No. 5,552,272) uses a thin film optical support to provide an enhanced level of exciting photons to an immobilized fluorescent labeled material wherein this support also increases the capture of the desired fluorescent emission.

Machler in U.S. Pat. No. 5,680,209 and U.S. Pat. No. 6,108,083 teaches the use of a step wave-guide for radiation which has been coupled by the use of cone-shaped aperture changers which have been arranged in the object between the light source and the sample or during absorption measurements between the sample and the inlet slot of a spectrometer which again adds to cost and increases the complexity of the system. Kreimer et. al. (U.S. Pat. No. 6,707,548 and U.S. Patent Application 20030227628) teaches the use of a plurality of wave guides each associated with a filter for a given wavelength of radiation to measure emitted fluorescent radiation from a sample which has been appropriately energized. The spectrographic measurements are then stored and processed by computers and used as diagnostic tools for samples, again a rather elaborate method for such a determination.

Turner et. al. (U.S. Pat. No. 6,707,556) and Gorfinkel et. al. (U.S. Pat. No. 5,784,157) teach the use of manipulations of incident or emitted radiation to optically analyze the fluorescence of fluorofors and thus limiting the utility of their methods.

Although the various approaches mentioned above have certain merits for each case, what is required now is a means to perform fluorescent measurements of very small samples efficiently and in an appropriate apparatus which in general can generate and direct the necessary exciting radiation into a container of the sample of interest and as the sample emits fluorescent radiation, measure the sample's fluorescent radiation generated while separating or otherwise differentiating that radiation from the excess incidental radiation. The system should be able to hold a sample in an inexpensive and readily available container which can be easily temperature controlled. The system preferably should be adaptable to a rapid, automated system which can rapidly determine the particulars of interest in the given samples.

Since many materials fluoresce upon irradiation, the composition of the container of the sample being examined must be selected so that it does not emit fluorescent radiation at the same wavelength as does the sample or otherwise interfere with the measurement of that sample's fluorescence. In addition, the actual shape of that container can reflect, generate and/or otherwise transmit such incident radiation in a manner such that it makes accurate measurement of the fluorescent radiation from the sample of interest to be detected and/or measured difficult. In addition when the sample is contained in an aqueous solution, a portion of water immiscible material such as an oil droplet resides on the surface of the sample to prevent evaporation or contamination during the processing of the sample and this causes aberrations in the fluorescence in question.

### DESCRIPTION OF THE PREFERRED SAMPLE CONTAINER

This invention uses a simple and readily available 12×75 mm test tube or ganged 12×75 mm test tubes made of some plastic material, although such a container could give off interfering fluorescent irradiation when the sample is illuminated due to its material of construction, injection molding gaps and the hemispherical shape of the bottom of the tube. This is especially true at or near the mold line where the cylindrical tube begins to become hemispherical to form the bottom of the tube which happens to be the point where the top of a small liquid sample of interest is situated. Also a particular source of aberrations are the fill vents at the very bottom of such a plastic tube which provide for very strong reflection of fluorescent emissions which may be present and/or generated in the tube. If an oil droplet is used to protect the sample, this difficulty would be compounded. As can be seen in the following drawings, these problems are addressed by the design of the fluorescence analytical system.

### BRIEF DESCRIPTION OF THE DRAWINGS

The present invention may be more fully understood from the following detailed description thereof when taken in connection with the accompanying drawings which form a part of this invention description in which:

FIG. 1 is a diagrammatic representation of a cross sectional view of the sample fluorescent radiation measurement device:

FIG. 2 is diagrammatic representation of a vertical view of the sample positioning and housing section.

### DETAILED DESCRIPTION OF THE FLUORESCENT RADIATION MEASUREMENT DEVICE

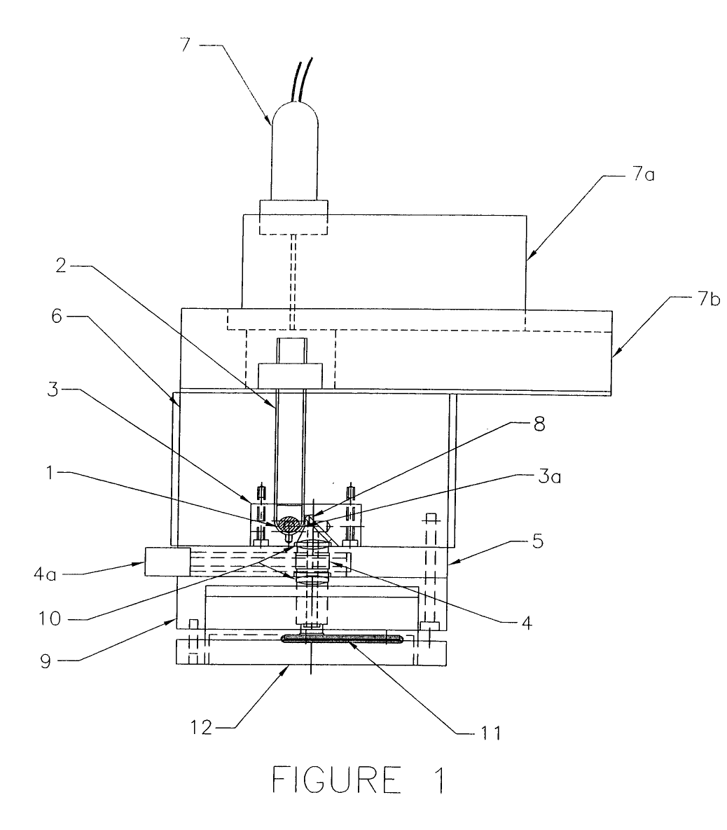

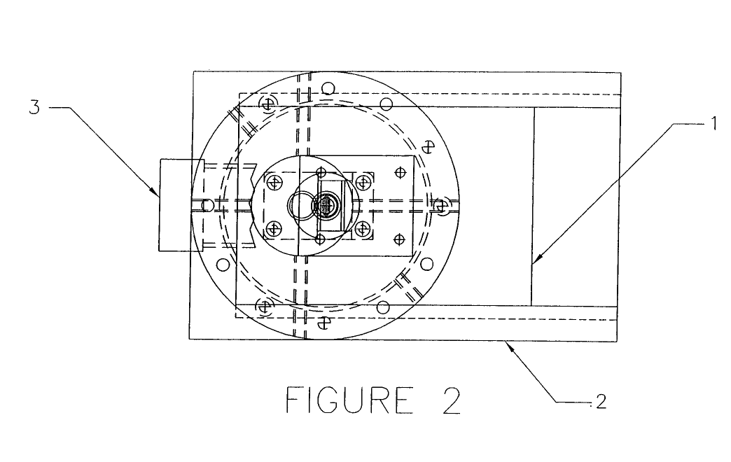

As can be seen FIG. 1 the necessary small amount of prepared sample to be analyzed by measuring its induced fluorescent radiation 1 is contained in a 12×75 mm plastic test tube which has the usual hemispherical bottom 2. This test tube is inserted into a sliding laser housing 7a and FIG. 2 number 1 as well as being held perpendicularly in place in the mirror housing FIG. 1, number 3 which has an aperture 3a; this aperture is positioned so that only radiation exiting the test tube just below the mold line can pass through that aperture 3a and therefore permits only radiation at a 90±2 degree angle from that of the incident radiation, in this case a laser emission generated in the laser module 7 to be reflected downward by the mirror 8 to the radiation filtering 4 and handling 10 apparatus.

The emission filter 4 is contained in the sliding emission filter housing 5a and FIG. 2 number 3 which in turn resides in a pocket FIG. 1 number 5 of the overall test tube housing/heat block 6. This sliding emission filter housing combined with the laser slide adapter 7b and FIG. 2 number 2 allows all necessary elements of the system to be properly positioned so that the collimated laser emission from the laser module 7 is always positioned perpendicularly above the center of the sample test tube so that the laser emission does not impact the wall of the test tube which, if it did, could generate stray emissions.

The sliding laser housing FIG. 1 number 4a and FIG. 2 number 3 is positioned to allow the selection of the necessary specific incident wave length most suitable to the sample being analyzed.

When the incident radiation contacts the sample it causes the sample to emit its own fluorescent radiation at a different wave length than that of the selected incident radiation and a selected portion of the combined radiation which flows from the sample test tube just below the mold line through the aperture FIG. 1 number 3a and is reflected downward by the mirror 8 to the measuring device in the same perpendicular direction as the incident laser emission but aside from the same perpendicular path of the original incident laser emission.

Positioned directly below the mirror 8 is the lower lens housing 9 holding two lenses 10 separated by the emission filter 4 which filter removes any radiation not generated by the sample; the lenses 10 refocus any stray emissions that may have been generated by the curvature of the lower part of the test tube 2 and the reflecting mirror 8 as well as by the emission filter 4.

The focused sample fluorescent radiation then proceeds to the photodiode PC board 11 contained in the PC board housing 12 which measures the amount (if any) of the fluorescent radiation which has been emitted by the sample in question.

In another embodiment of this invention multiple excitation sources of the same or different types and with changeable excitation filters may be employed to facilitate real-time fluorescent radiation measurements simultaneously on multiple test tubes containing samples. Along with the multiplexed and/or multiple excitation sources and excitation filter sets, multiple and/or multiplexed mirrors, emission filters, focusing optic sets and detectors can also be employed to make rapid (in the order of fractional seconds to several seconds repetition rate), simultaneous fluorescent radiation measurements on multiple samples in test tubes at multiple wavelengths. In doing so simultaneous real time measurements could be accomplished. This is useful to detect the emergence time of the fluorescent enzymes used to detect the presence and quantity of disease organisms found in human patients or other species.

To achieve multiplexed operation of one or several excitation sources, the prepared patient samples could be placed in a carousel and then passed beneath the excitation sources. Synchronization of firing of the excitation source with the passage of the patient sample beneath it provides multiplexed excitation. In addition there are multiple dye sets that could lend themselves to be excited from one laser or laser diode module because of the closeness of their excitation bandwidths. The fluorescent signals emanating from such simultaneous or multiplexed excitations would be separated by use of separate emission filters/detector sets.

In another embodiment of this invention, similar multiple and/or multiplexed apertures, mirrors, emission filters, focusing/collimating lens sets and detectors may be employed along with the excitation sources above to facilitate rapid, real-time fluorescent radiation measurements of prepared patient samples in test tubes. These like the excitation sources must be synchronized to the relative movement between the prepared samples and the excitation sources in order to properly capture the fluorescent signal from the test tubes. The emission filters could be switched automatically to accommodate the particular properties of the dyes or sets of dyes used to prepare the assay samples.

In addition detectors may be fashioned from photodiode receivers or from photo multiplier tubes suitable for the detection of fluorescent radiation in the bandwidths determined by the dyes or dye sets chosen for the assay.

Also excitation sources may be lasers, laser diode modules or flash lamps/excitation filter sets.

### EXAMPLE 1

To demonstrate the Sensitivity and Dynamic Range of this system, duplicates of a serial dilution of Cy5 Labeled Oligonucleotides was determined and plotted over three decades of concentration. A dashed linear line has been overlaid on the data points to indicate the expected straight line response. The background value was subtracted from each data point.

At a laser diode excitation of about 1.5 mW with this system, amplifier gain and A/D converter chosen, the system has 2.5-3 decades of dynamic range and a sensitivity of approximately 3×10⁻¹⁴ mole/100 μL of sample.

[image]

This invention is seen to be very advantageous since it allows the user to simply and quickly determine the amount of fluorescent radiation of the desired wavelength from a sample of interest contained in a simple, inexpensive and readily available plastic tube without interference from incident or other stray wave lengths which could contribute to errors in the assay. This system can be incorporated into the design and manufacture of a very high throughput testing instrument. Also the use of this system in any format will allow fluorescent radiation determinations to be conducted efficiently by an alert operator who might not have had major scientific training.

Optional changes to a number of the above segments of this invention including adaptation to other readily available sample containers will be obvious to one skilled in the art.

1. A simple system of accurately measuring the fluorescent radiation of a sample of interest in a suitable container by:
a. exciting said sample with selected incident radiation which is directed to the sample in its container so that the incident radiation does not first strike any material which could emit interfering stray radiation, and
b. the selected incident radiation contacts the sample directly from above causing it to emit its own expected fluorescent radiation, and
c. a selected portion of that combined radiation with interfering specular noise removed is reflected perpendicularly to a focusing lens and the focused radiation is then passed through a filter that removes all radiation other than that generated by the sample, and
d. the sample's radiation is again focused and proceeds to a photodiode detector, and
e. which detector identifies the presence and amount of the expected radiation and displays that result through interaction with a program of an electronic processor.

2. The system of claim 1 wherein the excitation source is a Xenon flash tube

3. The system of claim 1 wherein the excitation source is a laser

4. The system of claim 1 wherein the excitation source is a laser diode module

5. The system of claim 1 where multiple excitation sources are used

6. The method of claim 5 where changeable excitation filters are used in conjunction with the multiple excitation sources

7. The method of claim 6 where multiplexed and/or multiple mirrors are used in conjunction with the multiple excitation sources

8. The method of claim 6 where multiplexed and/or multiple emission filters are used with the multiple excitation sources

9. The method of claim 6 where multiplexed and/or multiple focusing optic sets and detectors are used with the multiple excitation sources

10. The system of claim 1 wherein the excitation source is chosen to excite the particular dye or dyes used with the sample

11. The system of claim 1 where the sample container is a 12×75 mm plastic test tube

12. The system of claim where the sample container is a 12×75 mm glass test tube

13. The system of claim 1 where the sample containers are placed in a carousel to be passed beneath the excitation source or sources

14. The system of claim 1 where the firing of the excitation source or sources is synchronized with passage of the patient samples beneath them

15. The system of claim 1 where fluorescent radiation of several wavelengths generated by a sample are separated by the use of separate emission filters or detector sets.

16. The system of claim 1 where similar multiple and/or multiplexed apertures mirrors, emission filters, focusing/collimating lens sets and detectors are employed with the excitation source or sources

17. The system of claim 1 where the emission filters are switched automatically to accommodate the properties of the dye set used in the preparation of the samples being examined

18. The system of claim 1 where the detectors are fashioned from photodiode receivers or photo multiplier tubes suitable for the detection of the specific fluorescent radiation in the bandwidths determined by the dyes or dye sets use in the preparation of the samples being examined

19. The system of claim 1 where the result is displayed by use of a personal computer

20. The system of claim 1 where the results are displayed by use of an embedded computer.

21. An instrument using the system described in claim 1.
